(19) United States
(12) Patent Application Publication
(10) Pub. No.: US 2022/0005653 A1
(43) Pub. Date: Jan. 6, 2022

(54) DYNAMIC KEYBOARD

(71) Applicant: TACTUAL LABS CO., New York, NY (US)

(72) Inventors: Mark Bisbee, Los Gatos, CA (US); Braon Moseley, Round Rock, TX (US)

(73) Assignee: TACTUAL LABS CO., New York, NY (US)

(21) Appl. No.: 17/288,853

(22) PCT Filed: Oct. 25, 2019
(86) PCT No.: PCT/US2019/058174

§ 371 Date: Apr. 26, 2021

Related U.S. Application Data
(60) Provisional application No. 62/751,427, filed on Oct. 26, 2018.

(51) Int. Cl. H01H 13/85; A63F 13/24; H01H 13/79; H01H 13/803; G06F 3/02; G06F 3/023

(52) U.S. Cl. CPC H01H 13/85; A63F 13/24; H01H 13/79; H01H 13/803; G06F 3/0219; H01H 2231/008; H01H 2239/006; H01H 2227/034; H01H 2215/028; H01H 2215/044; G06F 3/0238

(57) ABSTRACT

A dynamic keyboard able to change and adapt the functionality of the keyboard depending on the scenario in which it is being implemented. Each key can have one or more modes assigned to it that is able to change depending on the use. Groups of keys can have more than one mode assigned to it. Different groups of keys can have different modes assigned to them.

This application claims the benefit of U.S. Provisional Application No. 62/751,427 filed Oct. 26, 2018, the contents of which are herein incorporated by reference. This application is also a continuation-in-part of U.S. patent application Ser. No. 16/384,050 filed Apr. 15, 2019, which in turn claims the benefit of U.S. Provisional Application No. 62/657,160 filed Apr. 13, 2018, the disclosure of each of which is herein incorporated by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed systems relate in general to the field of keyboards, and in particular to dynamic keyboards sensitive to touch, including, hover and pressure.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is a high-level block diagram illustrating an embodiment of a low-latency touch sensor device.

FIG. 2 shows a mechanical key switch used with keyboards.

FIG. 3 shows the mechanical key switch of FIG. 2 in a depressed state.

FIG. 4 shows a key switch having a receiving antenna and a transmitting antenna.

FIG. 5 shows the key switch of FIG. 4 in a depressed state.

FIG. 6 shows a printed circuit board used in conjunction with the key switch shown in FIGS. 4 and 5.

FIG. 7 shows a dynamic keyboard.

### DETAILED DESCRIPTION

In various embodiments, the present disclosure is directed to systems (e.g., objects, panels or keyboards) sensitive to hover, contact and pressure and their applications in real-world, artificial reality, virtual reality and augmented reality settings. It will be understood by one of ordinary skill in the art that the disclosures herein apply generally to all types of systems using fast multi-touch to detect hover, contact and pressure. In an embodiment, the present system and method can be applied to keyboards, including but not limited to membrane keyboards, dome-switch keyboards, scissor-switch keyboards, capacitive keyboards, mechanical-switch keyboards, buckling-spring keyboards, hall-effect keyboards, laser projection keyboard, roll-up keyboards, and optical keyboard technology.

Throughout this disclosure, the terms “touch”, “touches”, “touch event”, “contact”, “contacts”, “hover”, or “hovers” or other descriptors may be used to describe events or periods of time in which a key, key switch, user's finger, a stylus, an object, or a body part is detected by a sensor. In some sensors, detections occur only when the user is in physical contact with a sensor, or a device in which it is embodied. In some embodiments, and as generally denoted by the word “contact”, these detections occur as a result of physical contact with a sensor, or a device in which it is embodied. In other embodiments, and as sometimes generally referred to by the term “hover”, the sensor may be tuned to allow for the detection of “touches” that are hovering at a distance above the touch surface or otherwise separated from the sensor device and causes a recognizable change, despite the fact that the conductive or capacitive object, e.g., a finger, is not in actual physical contact with the surface. Therefore, the use of language within this description that implies reliance upon sensed physical contact should not be taken to mean that the techniques described apply only to those embodiments; indeed, nearly all, if not all, of what is described herein would apply equally to “contact” and “hover”, each of which is a “touch”. Generally, as used herein, the word “hover” refers to non-contact touch events or touch, and as used herein the term “hover” is one type of “touch” in the sense that “touch” is intended herein. Thus, as used herein, the phrase “touch event” and the word “touch” when used as a noun include a near touch and a near touch event, or any other gesture that can be identified using a sensor. “Pressure” refers to the force per unit area exerted by a user contact (e.g., presses by their fingers or hand) against the surface of an object. The amount of “pressure” is similarly a measure of “contact”, i.e., “touch”. “Touch” refers to the states of “hover”, “contact”, “pressure”, or “grip”, whereas a lack of “touch” is generally identified by signals being below a threshold for accurate measurement by the sensor. In accordance with an embodiment, touch events may be detected, processed, and supplied to downstream computational processes with very low latency, e.g., on the order of ten milliseconds or less, or on the order of less than one millisecond.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency-orthogonal to each other, in which case, they could not be the same frequency.

The present application contemplates various embodiments of sensors designed for implementation in keyboards, and specifically to implement the sensors in a manner that permits dynamic control and responsiveness of the keyboard. The sensor configurations are suited for use with frequency-orthogonal signaling techniques (see, e.g., U.S. Pat. Nos. 9,019,224 and 9,529,476, and 9,811,214, all of which are hereby incorporated herein by reference). The sensor configurations discussed herein may be used with other signal techniques including scanning or time division techniques, and/or code division techniques. It is pertinent to note that the sensors described and illustrated herein are also suitable for use in connection with signal infusion (also referred to as signal injection) techniques and apparatuses.

The presently disclosed systems and methods involve principles related to and for designing, manufacturing and using capacitive based sensors, and particularly capacitive based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicants' prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors which may be used in connection with the presently disclosed sensors. In such sensors, interactions are sensed when a signal from a row is coupled (increased) or decoupled (decreased) to a column and the result received on that column. By sequentially exciting the rows and measuring the coupling of the excitation signal at the columns, a heatmap reflecting capacitance changes, and thus proximity, can be created.

This application also employs principles used in fast multi-touch sensors and other interfaces disclosed in the following: U.S. Pat. Nos. 9,933,880; 9,019,224; 9,811,214; 9,804,721; 9,710,113; and 9,158,411. Familiarity with the disclosure, concepts and nomenclature within these patents is presumed. The entire disclosure of those patents and the applications incorporated therein by reference are incorporated herein by reference. This application also employs principles used in fast multi-touch sensors and other interfaces disclosed in the following: U.S. patent application Ser. Nos. 15/162,240; 15/690,234; 15/195,675; 15/200,642; 15/821,677; 15/904,953; 15/905,465; 15/943,221; 62/540,458, 62/575,005, 62/621,117, 62/619,656 and PCT publication PCT/US2017/050547, familiarity with the disclosures, concepts and nomenclature therein is presumed. The entire disclosure of those applications and the applications incorporated therein by reference are incorporated herein by reference.

Certain principles of a fast multi-touch (FMT) sensor have been disclosed in patent applications discussed above. Orthogonal signals are transmitted into a plurality of transmitting conductors (or antennas) and the information received by receivers attached to a plurality of receiving conductors (or antennas), the signal is then analyzed by a signal processor to identify touch events. The transmitting conductors and receiving conductors may be organized in a variety of configurations, including, e.g., a matrix where the crossing points form nodes, and interactions are detected at those nodes by processing of the received signals. In an embodiment where the orthogonal signals are frequency orthogonal, spacing between the orthogonal frequencies, Δf, is at least the reciprocal of the measurement period τ, the measurement period τ being equal to the period during which the columns are sampled. Thus, in an embodiment, a column may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to a row. In an embodiment, the signal processor of the mixed signal integrated circuit (or a downstream component or software) performs a Fourier transform to received signals. In an embodiment, the mixed signal integrated circuit is adapted to digitize received signals. In an embodiment, the mixed signal integrated circuit (or a downstream component or software) is adapted to digitize received signals and perform a discrete Fourier transform (DFT) on the digitized information. In an embodiment, the mixed signal integrated circuit (or a downstream component or software) is adapted to digitize received signals and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., window) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that, the term orthogonal as used herein is not “violated” by such small contributions. In other words, as we use the term frequency orthogonal herein, two signals are considered frequency orthogonal if substantially all of the contribution of one signal to the DFT bins is made to different DFT bins than substantially all of the contribution of the other signal.

In an embodiment, received signals are sampled at at least 1 MHz. In an embodiment, received signals are sampled at at least 2 MHz. In an embodiment, received signals are sampled at 4 Mhz. In an embodiment, received signals are sampled at 4.096 Mhz. In an embodiment, received signals are sampled at more than 4 MHz.

To achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at e.g., 4 MHz would yield an integration period slightly longer than a millisecond, and not achieving kHz sampling, and a minimum frequency spacing of 976.5625 Hz.) In an embodiment, the frequency spacing is equal to the reciprocal of the integration period. In such an embodiment, the maximum frequency of a frequency-orthogonal signal range should be less than 2 MHz. In such an embodiment, the practical maximum frequency of a frequency-orthogonal signal range should be less than about 40% of the sampling rate, or about 1.6 MHz. In an embodiment, a DFT (which could be an FFT) is used to transform the digitized received signals into bins of information, each reflecting the frequency of a frequency-orthogonal signal transmitted which may have been transmitted by the transmit antenna 130. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency-orthogonal signal that is transmitted. In an embodiment, each DFT (which can be an FFT) bin comprises an in-phase (I) and quadrature (Q) component. In an embodiment, the sum of the squares of the I and Q components is used as a measure corresponding to signal strength for that bin. In an embodiment, the square root of the sum of the squares of the I and Q components is used as a measure corresponding to signal strength for that bin. It will be apparent to a person of skill in the art in view of this disclosure that a measure corresponding to the signal strength for a bin could be used as a measure related to biometric activity. In other words, the measure corresponding to signal strength in a given bin would change as a result of some activity.

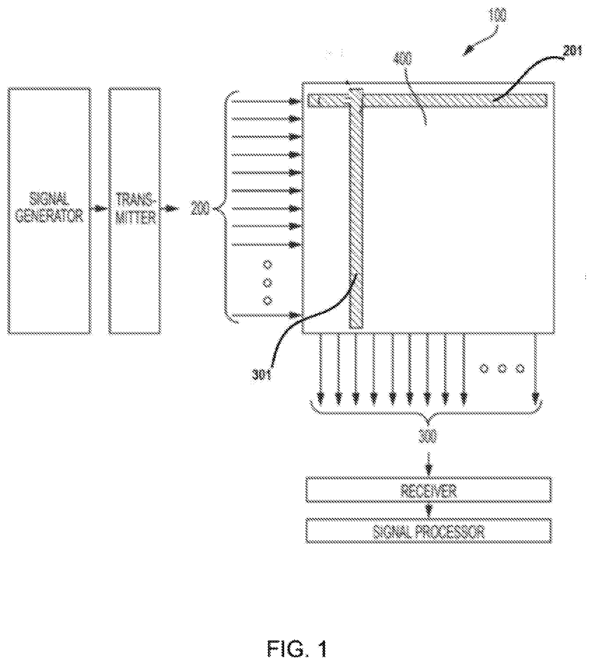

FIG. 1 illustrates certain principles of a sensor 100 in accordance with an embodiment. At 200, a different signal is transmitted into each of the rows 201 of the sensor surface 400. The signals are designed to be “orthogonal”, i.e., separable and distinguishable from each other. At 300, a receiver is attached to each column 301. The rows 201 and the columns 301 are conductors/antennas that are able to transmit and/or receive signals. The receiver is designed to receive any of the transmitted signals, or an arbitrary combination of them, with or without other signals and/or noise, and to individually determine a measure, e.g., a quantity for each of the orthogonal transmitted signals present on that column 301. The sensor surface 400 of the sensor comprises a series of rows 201 and columns 301 (not all shown), along which the orthogonal signals can propagate. In an embodiment, the rows 201 and columns 301 are arranged such that an interaction event will cause a change in coupling between at least one of the rows and at least one of the columns. In an embodiment, an event, such as a touch event or other interactive event will cause a change in the amount (e.g., magnitude) of a signal transmitted on a row that is detected in the column. In an embodiment, an event will cause a change in the phase of a signal transmitted on a row that is detected on a column. Because the sensor ultimately detects an event due to a change in the coupling, it is not of specific importance, except for reasons that may otherwise be apparent to a particular embodiment, the type of change that is caused to the event-related coupling by a touch or other interaction. As discussed above, the touch, or event does not require a physical touching or interaction, but rather an event that affects the coupled signal. In an embodiment the event does not require a physical touching, but rather an event that affects the coupled signal in a repeatable or predictable manner.

With continued reference to FIG. 1, in an embodiment, generally, the result of an event in the proximity of both a row 201 and column 301 causes a change in the signal that is transmitted on a row as it is detected on a column. In an embodiment, the change in coupling may be detected by comparing successive measurements on the column. In an embodiment, the change in coupling may be detected by comparing the characteristics of the signal transmitted on the row to a measurement made on the column. In an embodiment, a change in coupling may be measured by both comparing successive measurements on the column and by comparing known characteristics of the signal transmitted on the row to a measurement made on the column. More generally, events cause, and thus correspond to, measurements of the signals on the columns 301. Because the signals on the rows 201 are orthogonal, multiple row signals can be coupled to a column 301 and distinguished by the receiver. Likewise, the signals on each row 201 can be coupled to multiple columns 301. For each column 301 coupled to a given row 201 (and regardless of how interaction affects the coupling between the row and column), the signals measured on the column 301 contain information that will indicate which rows 201 are being interacted with simultaneously with that column 301. The magnitude or phase shift of each signal received is generally related to the amount of coupling between the column 301 and the row 201 carrying the corresponding signal, and thus, may indicate a distance of the interacting object to the surface, an area of the surface covered by the event and/or the pressure of the event.

In various implementations of a device, physical contact with the rows 201 and/or columns 301 is unlikely or impossible as there may be a protective barrier between the rows 201 and/or columns 301 and the finger or other object of an event. Moreover, generally, the rows 201 and columns 301 themselves are not in physical contact with each other, but rather, placed in a proximity that allows signal to be coupled there-between, and that coupling changes with an event. Generally, the row-column coupling results not from actual contact between them, nor by actual contact from the finger or other object of an event, but rather, by the effect of bringing the finger (or other object) into proximity—which proximity results in a change of coupling, which effect is referred to herein as an event.

In an embodiment, the orientation of the rows and columns may vary as a consequence of a physical process, and the change in the orientation (e.g., movement) of the rows and/or columns with respect to one-another may cause a change in coupling. In an embodiment, the orientation of a row and a column may vary as a consequence of a physical process, and the range of orientation between the row and column include ohmic contact, thus in some orientations within a range a row and column may be in physical contact, while in other orientations within the range, the row and column are not in physical contact and may have their coupling varied. In an embodiment, when a row and column are not in physical contact their coupling may be varied as a consequence of moving closer together or further apart. In an embodiment, when a row and column are not in physical contact their coupling may be varied as a consequence of grounding. In an embodiment, when a row and column are not in physical contact their coupling may be varied as a consequence of materials translated within the coupled field. In an embodiment, when a row and column are not in physical contact their coupling may be varied as a consequence of a changing shape of the row or column, or an antenna associated with the row or column.

The nature of the rows 201 and columns 301 is arbitrary and the particular orientation is variable. Indeed, the terms row 201 and column 301 are not intended to refer to a square grid, but rather to a set of conductors upon which signal is transmitted (rows) and a set of conductors onto which signal may be coupled (columns). (The notion that signals are transmitted on rows 201 and received on columns 301 itself is arbitrary, and signals could as easily be transmitted on conductors arbitrarily designated columns and received on conductors arbitrarily named rows, or both could arbitrarily be named something else.) Further, it is not necessary that rows and columns are in a grid. Other shapes are possible as long as an event will affect a row-column coupling. For example, the “rows” could be in concentric circles and the “columns” could be spokes radiating out from the center.

And neither the “rows” nor the “columns” need to follow any geometric or spatial pattern, thus, for example, the keys on a keyboard could be arbitrarily connected to form rows and columns (related or unrelated to their relative positions). Moreover, an antenna may be used as a row (e.g., having a more defined shape than a simple conductor wire such as for example a row made from ITO). For example, an antenna may be round or rectangular, or have substantially any shape, or a shape that changes. An antenna used as a row may be oriented in proximity to one or more conductors, or one or more other antennas that act as columns. In other words, in an embodiment, an antenna may be used for signal transmission and oriented in proximity to one or more conductors, or one or more other antennas that are used to receive signals. An event will change the coupling between the antenna used for signal transmission and the signal used to receive signals. It should be understood that the terms, “conductor”, “antenna” or “electrode” may be used herein to represent the same object or concept or alternatively be used in place of the other term. One of ordinary skill familiar with this disclosure would be able to understand which of the terms “conductor,” “antenna” or “electrode” may be applicable in a given scenario and that usage of any one of the terms in any of the embodiments or disclosure provided herein should not be considered limiting unless specifically intended by the accompanying text.

It is not necessary for there to be only two types signal propagation channels: instead of rows and columns, in an embodiment, channels “A”, “B” and “C” may be provided, where signals transmitted on “A” could be received on “B” and “C”, or, in an embodiment, signals transmitted on “A” and “B” could be received on “C”. It is also possible that the signal propagation channels can alternate function, sometimes supporting transmitters and sometimes supporting receivers. It is also contemplated that the signal propagation channels can simultaneously support transmitters and receivers—provided that the signals transmitted are orthogonal, and thus separable, from the signals received. Three or more types of antenna or conductors may be used rather than just “rows” and “columns.” Many alternative embodiments are possible and will be apparent to a person of skill in the art after considering this disclosure. It is likewise not necessary for there to be only one signal transmitted on each transmitting media. In an embodiment, multiple orthogonal signals are transmitted on each row. In an embodiment, multiple orthogonal signals are transmitted on each transmit antenna.

Returning briefly to FIG. 1, as noted above, in an embodiment the sensor surface 400 comprises a series of rows 201 and columns 301, along which signals can propagate. As discussed above, the rows 201 and columns 301 are oriented so that, when they are not being interacted with the signals are coupled differently than when they are being interacted with. The change in signal coupled between them may be generally proportional or inversely proportional (although not necessarily linearly proportional) to the event such that the touch or interaction is measured as a gradation, permitting distinction between more interaction (i.e., closer or firmer) and less interaction (i.e., farther or softer)—and even no interaction.

At 300, a receiver is attached to each column 301. The receiver is designed to receive the signals present on the columns 301, including any of the orthogonal signals, or an arbitrary combination of the orthogonal signals, and any noise or other signals present. Generally, the receiver is designed to receive a frame of signals present on the columns 301, and to identify the columns providing signal. A frame of signals is received during an integration period or sampling period. In an embodiment, the receiver (or a signal processor associated with the receiver data) may determine a measure associated with the quantity of each of the orthogonal transmitted signals present on that column 301 during the time the frame of signals was captured. In this manner, in addition to identifying the rows 201 interacting with each column 301, the receiver can provide additional (e.g., qualitative) information concerning the event. In general, events may correspond (or inversely correspond) to the received signals on the columns 301. For each column 301, the different signals received thereon indicate which of the corresponding rows 201 is being interacted with simultaneously with that column 301. In an embodiment, the amount of coupling between the corresponding row 201 and column 301 may indicate e.g., the area of the surface covered by the interaction, the pressure of the interaction, etc. In an embodiment, a change in coupling over time between the corresponding row 201 and column 301 indicates a change in the interaction at the intersection of the two.

The sensor 100 shown in FIG. 1, as well as the sensing methodologies, provides the framework for the discussion related to the dynamic keyboard discussed in more detail below. The sensitivity to various events set forth in the discussion of the sensor 100 can be applied to key switches for keyboards and for keyboard overlays for sensors and sensor surfaces. The row 201 and column 301 arrangement and variations thereof can be used to provide the substrate upon which a keyboard can be mapped. In an embodiment, touch, touch events and events correspond to keystrokes and other activities implemented through the keyboard and keys.

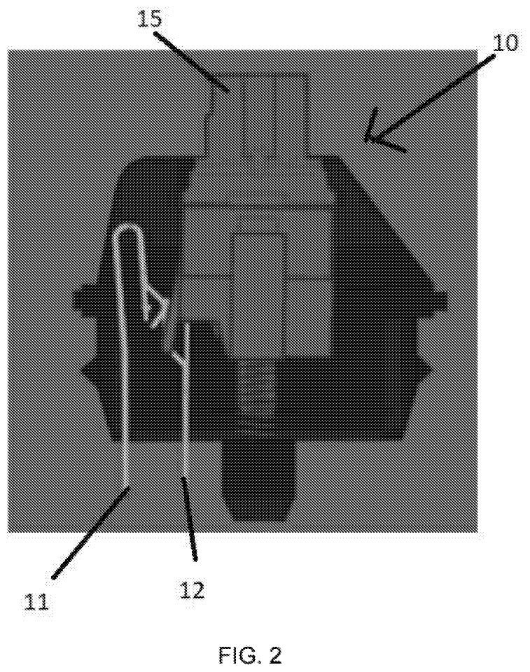

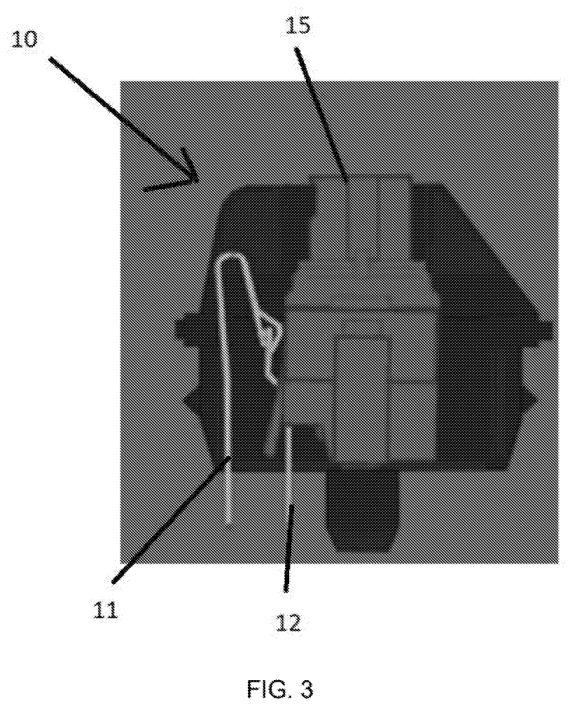

Turning to FIGS. 2 and 3, shown is a key switch 10 that is known as a Cherry MX red switch. When this key switch 10 is used, actuation of the key switch 10 occurs when the stem 15 slides in a manner so that as it moves downwards, the first switch part 11 and the second switch part 12 come into contact with each other. When the stem 15 slides past the first switch part 11, the portion of the stem 15 that prevented any contact between the first switch part 11 and the second switch part 12 is moved. The contact between the first switch part 11 and the second switch part 12 occurs prior to a portion of the stem 15 hitting the bottom of the keyboard where the key switch 10 is secured.

A key switch 10 designed in the manner discussed above permits quick responses during typing or gaming activity. Key switches 10 may be mounted on plates or printed circuit boards (PCBs). When using the key switch 10 shown in FIGS. 2 and 3 the contact between the first switch part 11 and the second switch part 12 completes a circuit and registers as a struck key.

Instead of completing a circuit, as shown in FIGS. 2 and 3, a key switch can be modified and connected to sensors in a manner that will permit registering of information during various levels of activity of a key press. This is accomplished by implementing a PCB board, or other architecture that employs transmitting conductors and receiving conductors that are operatively connected to signal generators, receivers and processors. In an embodiment, a unique frequency orthogonal signal is transmitted down each of the transmitting conductors and a measure of each unique frequency signal received is determined by a processor operatively connected to the keyboard. In an embodiment, the keyboard can detect events occurring both on and above the keyboard using a sensor configuration commensurate with the sensor discussed above in FIG. 1. In an embodiment, multiple different events are detected on the keyboard using a sensor configuration commensurate with the sensor discussed above. In an embodiment, each of the events detected on the keyboard is related to a specific keystroke. In an embodiment, the distance of each of the keystrokes above the keyboard can convey different key related activities via the interaction.

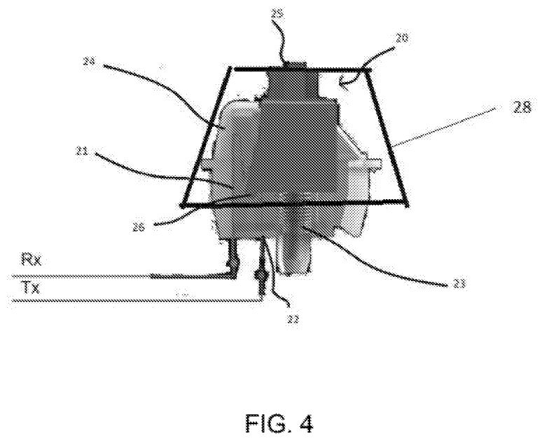

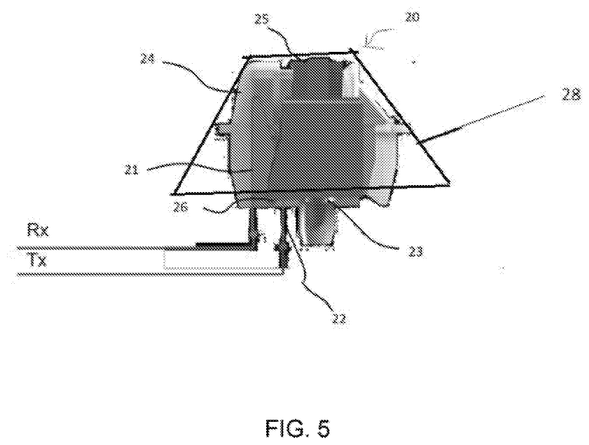

Turning to FIGS. 4 and 5, an embodiment is shown of a key switch 20 adapted to be implemented on a dynamic keyboard. The key switch 20 illustrated in FIGS. 4 and 5 provides an additional level of granularity with respect to the interaction that can occur on the keyboard. The key switch 20 has a stem 25 and a housing 24. Located within the housing 24 are receiving switch 21 and transmitting switch 22. When reference is made to a switch herein it is to be understood that the switch is a type of conductor, electrode or antenna within the context used above. In other words, the transmitter switch and the receiver switch are extensions of the transmitting and receiving conductors. A spring 23 is operably connected to the stem 25. Additionally, extending from the stem 25 is a sloped projection 26. When implemented on a keyboard, a cover 28 is placed over the key switch 20, thereby forming the key of the keyboard. In an embodiment the cover covers the entire key switch. In an embodiment the key switch covers only a portion of the key switch. In an embodiment. In an embodiment, the key switch 20 is one of a plurality of key switches 20 located on a keyboard.

The stem 25 and the housing 24 are situated so that the stem 25 partially extends from the housing 24 during a non-depressed state. The stem 25 is located in this default state due to the biasing of spring 23. The spring 23 is operably connected to the stem 25. When the stem 25 is pressed, the movement of the stem 25 compresses the spring 23. Cessation of pressing of the stem 25 will permit the stem 25 to return to its non-depressed state due to the biasing force of the spring 23. In an embodiment, other means are used to return the stem 25 to the non-depressed state, such as the natural resting state of materials used for the key.

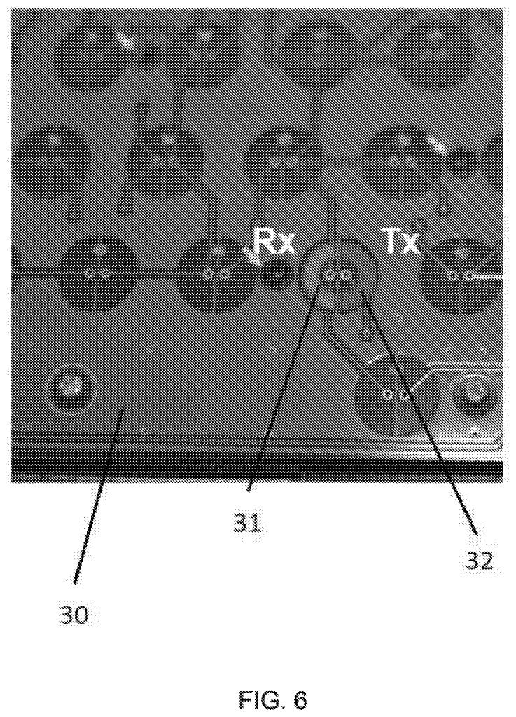

In the non-depressed state, the receiving switch 21 and the transmitting switch 22 are not contacting each other. The receiving switch 21 is operably connected to a receiving conductor 31 (shown in FIG. 6). The transmitting switch 22 is operably connected to the transmitting conductor 32 (shown in FIG. 6). While the receiving switch 21 and the transmitting switch 22 are not contacting each other, the transmitting switch 22 and the receiving conductor 31 are capable of transmission and receipt of signals. Indeed, it is intended that the transmitting switch 22 will periodically transmit signals and the transmission of signals will be received at the receiving switch 21. In an embodiment the transmitting switch is constantly transmitting signals. In an embodiment the transmitting switch only transmits signals when the key is pressed. In an embodiment, the transmitting switch is one of a plurality of transmitting switches transmitting signals and the receiving switch is adapted to receive signals from each transmitting switch transmitting a signal.

In an embodiment, the roles of the transmitting switch 22 and the receiving switch 21 are reversed (i.e. the receiving switch 21 is connected to the transmitting conductor 32 and the transmitting switch 22 is connected to the receiving conductor 31). In an embodiment, the transmitting switch 22 is operably connected to more than one transmitting conductor 32. In an embodiment the receiving switch 21 is connected to more than one receiving conductor 31. In an embodiment both the receiving switch 21 and the transmitting switch 22 are connected to more than one receiving conductor 31 and/or transmitting conductors 32. In an embodiment the receiving switch 21 changes between being connected to a receiving conductor 31 and a transmitting conductor 32. In an embodiment the transmitting switch 22 varies between being connected to a receiving conductor 31 and transmitting conductors 32.

Still referring to FIGS. 4 and 5, the receiving switch 21 is located within the housing 24 so that it remains in a stable position. In an embodiment, the receiving switch 21 is biased so that without pressure on it a portion of it will be biased towards the center of the housing 24. The sloped projection 26 extends at an angle with respect to the stem 25. The sloped projection 26 presses against the receiving switch 21 so that the receiving switch 21 is biased against the sloped projection 26 during the non-depressed state of the stem 25. The angle at which the sloped projection 26 is sloped controls the timing of when the receiving switch 21 comes into contact with the transmitting switch 22. In the embodiment shown in FIGS. 4 and 5, the sloped projection is sized and sloped so that the transmitting switch 22 and the receiving switch 21 only come into contact with each other when the key switch 20 is fully depressed.

As the stem 25 is depressed the biasing of the receiving switch 21 will cause it to move towards the center of the housing 24 and up the slope of the sloped projection 26. When the stem 25 is fully depressed, the receiving switch 21 fully engages the transmitting switch 21. The contact of the receiving switch 21 with the transmitting switch 21 is registered a touch event different than the touch events registered as the switches approach each other or are at rest. When the stem 25 is not depressed, the spring 23 will bias the stem 25 upwards again. The approach of (and departure from) the receiving switch 21 to the transmitting switch 22 is detectable due to the transmission of signals from the transmitting switch 22. The signals are received by the receiving switch 21 and analyzed by a processor within the system. This creates a measurable quantity that can be evaluated and used to extract data regarding the position and movement of the key switch 20.

In an embodiment, the key switch 20 is mounted on a printed circuit board (PCB) 30, as shown in FIG. 6, that has located thereon a plurality of receiving conductors 31 and transmitting conductors 32. These receiving conductors 31 and transmitting conductors 32 are operably connected to the receiving switch 21 and the transmitting switch 22. In an embodiment there are a plurality of columns of receiving conductors 31 and a plurality of rows of transmitting conductors 32. In an embodiment there are six rows of transmitting conductors 32 by twenty columns of receiving conductors 31. In an embodiment, there are 104 keys with the remainder of the receiving conductors 31 and transmitting conductors 32 used for other activities besides the sensing of key presses and determination of touch events. For example, receiving conductors 31 and transmitting conductors 32 can be formed into an arrangement that is used for mouse tracking.

During operation of the key switch 20 shown in FIGS. 4 and 5, as the stem 25 is depressed and the receiving switch 21 and the transmitting switch 22 approach each other a signal or signals are transmitted via the transmitting switch 22. The signal or signals are received at the receiving switch 21. The coupling of signal between the transmitting switch 22 and the receiving switch 21 is measured and processed. By measuring the change in the coupling, the extent to which the stem 25 is depressed is measured. Full depression of the stem 25 can be ascertained when there is full contact between the transmitting switch 22 and the receiving switch 21.

Being able to measure slight changes in the amount the stem 25 is depressed (or non-depressed) can be used in assigning various functionality to the key switch 20. Furthermore, the position of a user's finger with respect to the key switch 20 can be ascertained at any point during the interaction of the user with the key switch 20. The position of the user's finger can be detected when approaching the key switch 20, when above the key switch 20, during the depression of the key switch 20 and release of the key switch 20.

In an embodiment, when more than one key switch is depressed a different functionality can occur. In an embodiment when more than one key switch is depressed to different extents different functionality occurs. In an embodiment different functionality occurs from partial depressions. In an embodiment different functionality occurs both during depression and when releasing a key. In an embodiment, different functionality is caused by different rates of depression and release. In an embodiment different functionality occurs during slow release of a key switch. In an embodiment the coupling caused by the approach of a finger to the transmitting switch 22 or receiving switch 21 is measured. In an embodiment predetermined sequences of key switch activity are used to alter activity of transmitting conductors 32 and receiving conductors 31 on the PCB 30. In an embodiment the position of the fingers over more than one key switch is used to make predictive determinations about future key presses. In an embodiment more than one key press is detected simultaneously. In an embodiment, some key switches are configured to predictively trigger activation of underlying software responses based on the movement of the approaching finger. For example, a gamer's character can predictively make a move (e.g., pull a trigger, etc.) based on the detection of an approaching finger.

In an embodiment, a hover distance of multiple centimeters can be determined using the receiving switches and the transmitter switches. In an embodiment, touch of a key is precisely determined by the interaction of a user's hands with the keyboard. In an embodiment mouse pad functionality is employed in some areas of the keyboard. In an embodiment, peripherals, other than a mouse, are adapted to be used on some areas of the keyboard through use of the transmitting and receiving conductors of the keyboard. In an embodiment, mouse pad functionality is implemented in the palm rest area of a gaming keyboard. In an embodiment, a USB passthrough is implemented in the keyboard. In an embodiment, a USB hub is built into keyboard.

In an embodiment, a signal generator and transmitter are operatively connected to each of the transmitting conductors 32 that are operably connected to the key switches. In embodiment, the key switches do not have separate transmitting and receiving switches and instead utilize the transmitting and receiving functionality of the PCB 30 in order to generate and determine the activity of fingers with the keyboard. The signal generator and the transmitter are configured to generate and transmit each of a plurality of frequency-orthogonal signals to each of the rows of transmitting conductors 32. In an embodiment, a receiver and signal processor are associated with each of the receiving conductors 31 and operatively connected thereto.

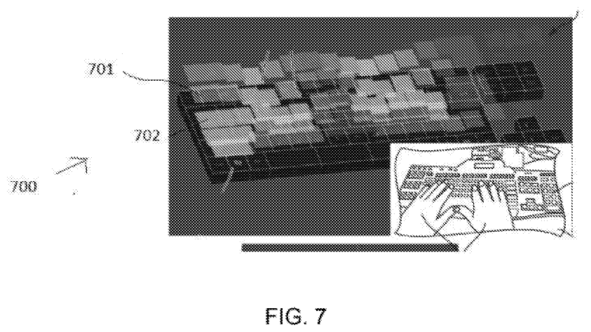

Referring to FIG. 7, an embodiment of a keyboard 700 is shown that implements the sensor technology and its implementation in with key technology discussed above. The keyboard 700 is able to take the ability to have differing characteristics and/or sensitivity to assign different functionality of the keys. Further, the key and sensor technology discussed above is able to be used to implement different modes of operation with respect to the keyboard and the software in which it interacts. In an embodiment, sensitivity of a first key and a second key are different. That is to say the first key is able to determine different amounts of activity more readily than the second key can. In an embodiment, responsiveness of a first key and a second key are different. In an embodiment, a first key and a second key are configured to have similar characteristics (e.g., latency, sensitivity, hover, responsiveness) until a condition is met, and then the first key and the second key are reconfigured to have differing characteristics. In an embodiment, the condition may be related to the software with which the keyboard is interacting (e.g., reaching a particular point in a game, or enabling a particular mode in a software program). In an embodiment, the condition may be related to a physical switch on the keyboard. In an embodiment, the condition may be related to the environment (e.g., sound level, light level, electrical signals). In an embodiment, the condition may be related to a user election, e.g. a selected keyboard configuration.

In an embodiment, the first key and the second key are deployed on an RGB keyboard or another keyboard with its own lighting associated with at least the first key and the second key. In a first mode, the first key and the second key are configured to have similar characteristics and the keyboard lighting responds similarly to them, and in a second mode, the first key and the second key are configured to have differing characteristics, and the keyboard lighting responds differently to them. As an example, in an embodiment, in a first mode the keyboard lighting responds as it normally does to the first and second keys, whereas in a second mode where the first key has increased hover sensitivity, the keyboard lighting changes (e.g., changes color or intensity) to reflect the change in the key's behavior.

The keyboard 700 is able to have assigned to it a first mode of operation to a first key or group of keys 701. The keyboard 700 is also able to have a second mode of operation assigned to a second key or group of keys 702. Additionally, each key may have one or more modes associated with it depending on the manner in which it is depressed. It should be understood that additional modes of operation may be assigned to a key or groups of keys in addition to the two already disclosed. Depending on the arrangement of the keys on the keyboard a key located in the first group of keys 701 may also be located in the second group of keys 702. Each group of keys or each key may have more than one mode of operation assigned to it. Keys that are formed into groups of keys do not have to be physically located next to each other and can be dispersed around the keyboard. In an embodiment, more than the two groups of keys have a mode or modes assigned to them. In an embodiment, each key has a different mode or modes assigned to it. In an embodiment, more than one mode is assigned to each group of keys. In an embodiment, some keys are adapted to have more than one mode, while other keys are adapted to have only one mode.

In addition to the first and second modes, the keyboard may have a variety of other modes that are able to be dynamically assigned to specific keys or groups of keys. By dynamically assigned it is meant that the key is provided with functionality either through predetermined programming, conditional situations, implementation situations and/or contextual situations. In an embodiment, a key or group of keys changes mode based on time. In an embodiment, a key or group of keys changes mode based on the context of the software implemented on a computer. In an embodiment, the key or group of keys changes mode based on the environment of the room or location in which the keyboard is being implemented. In an embodiment, the modes of keys are predetermined or preprogrammed. In an embodiment, the modes of keys are predetermined or programmed, but dynamically assigned based upon at least one additional factor.

Still referring to FIG. 7, for example, the first group of keys 701 may have a first mode that make those keys more sensitive (i.e. have less latency). The second group of keys 702 may have a second mode that make those keys assigned have less sensitivity (i.e. have more latency). In an embodiment, the modes may be related to multiple levels of sensitivity. In an embodiment, the modes may be related to “stickiness” of the keys. In an embodiment, the modes may be related to hover distance. In an embodiment, the modes may be related to tactile feel. In an embodiment, the modes may be related to texture of the keys (e.g., the keys texture may be altered by sensing a specific signal or series of signals that triggers beads or other features on the key cover to become raised). In an embodiment, the modes may be related to typing preference. In an embodiment, the modes may be related to game role functionality (i.e. walking mode, shooting mode, swimming mode, flying mode, etc.). In an embodiment, a portion of the keyboard may be switched to mouse or trackpad functionality depending on the mode. In an embodiment, the lighting of the keyboard may change depending on the modes of the key. In an embodiment, the modes may be selected from one or more of the above referenced modes.

Additionally, the mode of a key or group of keys can provide a particular haptic feedback. Haptic feedback is the sensation related to touch that the key or group of keys provide to the user. For example, in one mode a key can provide more resistance than when in another mode. In an embodiment, in one mode a key or group of keys becomes less resistive than when in another mode. In an embodiment, in one mode a key or group of keys provides vibrational feedback and in another mode provides no vibrational feedback. In an embodiment, a key or group of keys can provide different levels of vibrational feedback when in one mode than in another mode. In an embodiment, a key or group of keys can switch the haptic feedback of a mode based on hover distance from the keyboard. In an embodiment, the haptic feedback of a mode can change depending on the hover distance from the keyboard or the amount of the key depression. In an embodiment, the haptic feedback of a mode can change based on the mode or activity of another key or group of keys. For example, haptic feedback of modes may change based on anticipatory events or predicted keystrokes based on the activity of the program or motions of the user of the keyboard. In an embodiment, the haptic feedback of a mode of a key may change based on the rate of pressing of a key. For example, as the key is pressed and a transmitter switch approaches a receiver switch the mode of the key may change and subsequently impact the haptic feedback of the key. In an embodiment, the haptic feedback of key may change based on the amount of pressure applied to the key or group of keys. In an embodiment, the haptic feedback of a mode impacts the texture of a key or group of keys. In an embodiment, the haptic feedback of a mode or multiple set of modes is related to a sensation provided by a plurality of keys. For example, a plurality of keys may provide a ripple effect or provide other sensations or groups of sensations.

In an embodiment, separate keys or groups of keys are dynamically assigned different characteristics or functionalities depending on the features of the program for which it is being used. For example, if an approach is made by a character in a game to a specific location, the characteristics or functionality of one or more keys may change from being less sensitive to more sensitive. In an embodiment, keys or groups of keys are dynamically assigned different characteristics or functionalities depending on the role of a character in a game. In an embodiment, keys or groups of keys are dynamically assigned different functionalities depending on the tool of character. In an embodiment, keys or groups of keys are dynamically assigned different functionalities depending on the activity of a character. In an embodiment, keys or groups of keys are dynamically assigned different functionalities depending on the program running. In an embodiment, the mode of a key or the mode of a groups of keys are changed or assigned based on specific scenarios. In an embodiment, the mode of a key or the mode of a group of keys are changed or assigned based on user preferences. In an embodiment, the mode of a key or the mode of a group of keys are changed or assigned based on machine learning of previous actions of the user.

In an embodiment, the mode of a key or the mode of a group of keys are changed or assigned based on accessing a database comprising compiled data taken from a plurality of users. For example, a specific game may take data from a plurality of users and analyze the data to ascertain what a preferred key combination or sensitivity level may be for a plurality of users and implement preferred combinations accordingly. In an embodiment, the mode of a key or the mode of a set of keys may be changed or assigned based on determined environmental conditions of the room or area in which the keyboard is implemented. For example, specific key sensitivity may be improved depending on a temperature reading of the room (e.g. more sensitive when colder). For example, specific key sensitivity may be improved based on the humidity detected in the room. In an embodiment, a mode is assigned based on biometrics of the user of the keyboard. For example, modes of groups of keys or keys may be assigned based on a user's hand size or typing skill. For example, modes of groups of keys or keys may be assigned based on the force with which a user strikes the keys.

In addition to the functionality of the keys, other features of the keyboard may change depending on situations and positions of hands, etc. In an embodiment, the LED lighting of various keys or groups of keys are changed depending on use. In an embodiment, the LED lighting of various keys or groups of keys are changed based on anticipated actions. In an embodiment, the LED lighting of various keys or groups of keys can be changed based on learned user actions. In an embodiment, the LED lighting of various keys or groups of keys are changed based on hover distance from the keyboard. For example, the LED lighting of key changes on approach to the key. In an embodiment, LED lighting of the keyboard changes based on location and proximity to keys and groups of keys. In an embodiment, the LED lighting of various keys or groups of keys are based on the activity in the game or program. For example, specific keys that are anticipated to be used may be lit when that part of the game occurs. For example, the color of specific lights may change based on the scenario in the game (fighting versus exploring). For example, depending on the activity in the game, the color of lights may change when approaching a specific environment (for example, bright yellow for a desert environment, blue for an aquatic environment). In an embodiment, LED lighting may change based on the environment in which the keyboard is being used. For example, if the lighting in the room grows darker the key may light up more.

An aspect of the disclosure is a keyboard. The keyboard comprises a plurality of keys, wherein at least one of the plurality of keys comprises; a housing; a receiving switch located within the housing, wherein the receiving switch is operably connected to a receiving conductor; a transmitting switch located within the housing, wherein the transmitting switch is operably connected to a transmitting conductor, wherein the transmitting switch is adapted to transmit at least one signal; wherein depression of the least one of the plurality of keys causes the receiving switch and the transmitting switch to approach each other, wherein the receiving switch is adapted to receive the at least one signal transmitted from the transmitting switch, wherein interaction with the at least one of the plurality of keys is measurable by processing the at least one signal transmitted from the transmitting switch received by the receiving switch; and wherein the at least one of the plurality of keys is adapted to have at least a first mode and a second mode, wherein measured interaction with the at least one of the plurality of keys determines whether the at least one of the plurality of keys is in the first mode or the second mode.

Another aspect of the disclosure is a keyboard. The keyboard has a plurality of transmitting conductors, wherein each of the plurality of transmitter conductors is adapted to transmit at least one of a plurality of unique frequency orthogonal signals; a plurality of receiving conductors, wherein each of the plurality of receiving conductors is adapted to receive at least one of the plurality of unique frequency orthogonal signals a plurality of keys associated with the plurality of transmitting conductors and the plurality of receiving conductors; wherein interaction with at least one of the plurality of keys is determined using received signals; and wherein at least one of the plurality of keys is adapted to have at least a first mode and a second mode, interaction with the at least one of the plurality of keys determines whether the at least one of the plurality of keys is in the first mode or the second mode.

The several embodiments discussed above illustrate a variety of systems for keyboards, but are not intended to limit the scope of the claims. Other implementations to improve functionality of the keyboard and keys will become apparent to persons of skill in the art in view of this disclosure, and are thus included within the scope of this disclosure.

While the invention has been particularly shown and described with reference to a preferred embodiment thereof, it will be understood by those skilled in the art that various changes in form and details may be made therein without departing from the spirit and scope of the invention.

1. A keyboard, comprising:
a plurality of keys, wherein at least one of the plurality of keys comprises;
a housing;
a receiving switch located within the housing, wherein the receiving switch is operably connected to a receiving conductor;
a transmitting switch located within the housing, wherein the transmitting switch is operably connected to a transmitting conductor, wherein the transmitting switch is adapted to transmit at least one signal;
wherein depression of the least one of the plurality of keys causes the receiving switch and the transmitting switch to approach each other, wherein the receiving switch is adapted to receive the at least one signal transmitted from the transmitting switch, wherein interaction with the at least one of the plurality of keys is measurable by processing the at least one signal transmitted from the transmitting switch received by the receiving switch; and
wherein the at least one of the plurality of keys is adapted to have at least a first mode and a second mode, wherein measured interaction with the at least one of the plurality of keys determines whether the at least one of the plurality of keys is in the first mode or the second mode.

2. The keyboard of claim 1, wherein the at least one of the plurality of keys exhibits a first characteristic behavior in the first mode and a second characteristic behavior in the second mode.

3. The keyboard of claim 1, wherein depression of at least a second of the plurality of keys causes a second receiver switch and a second transmitter switch to approach each other, wherein interaction with the at least a second of the plurality of keys is measurable by processing at least a second signal transmitted from the transmitting switch received by the receiving switch; and
wherein the at least a second of the plurality of keys is adapted to have at least a third mode and a fourth mode, wherein measured interaction with the at least a second of the plurality of keys determines whether the at least a second of the plurality of keys is in the third mode or the fourth mode.

4. The keyboard of claim 3, wherein the at least a second of the plurality of keys exhibits a third characteristic behavior in the third mode and a fourth characteristic behavior in the second mode.

5. The keyboard of claim 3, wherein the third mode and the first mode are the same and the second mode and the fourth mode are the same.

6. The keyboard of claim 3, wherein the third mode and the first mode are different and the second mode and the fourth mode are different.

7. The keyboard of claim 1, wherein the at least one of the plurality of keys is further adapted to have a third mode.

8. The keyboard of claim 1, wherein the first characteristic behavior is resistance of a key depression.

9. The keyboard of claim 1, wherein the first characteristic behavior is a haptic behavior of the at least one of the plurality of keys.

10. The keyboard of claim 1, wherein the measured interaction is force of depression.

11. The keyboard of claim 1, wherein key is further adapted to switch modes based on a game interaction.

12. The keyboard of claim 1, wherein the measured interaction is hover.

13. The keyboard of claim 1, wherein the measured interaction determines LED lighting of the keyboard.

14. A keyboard, comprising:
a plurality of transmitting conductors, wherein each of the plurality of transmitter conductors is adapted to transmit at least one of a plurality of unique frequency orthogonal signals;
a plurality of receiving conductors, wherein each of the plurality of receiving conductors is adapted to receive at least one of the plurality of unique frequency orthogonal signals;
a plurality of keys associated with the plurality of transmitting conductors and the plurality of receiving conductors;
wherein interaction with at least one of the plurality of keys is determined using received signals; and
wherein at least one of the plurality of keys is adapted to have at least a first mode and a second mode, interaction with the at least one of the plurality of keys determines whether the at least one of the plurality of keys is in the first mode or the second mode.

15. The keyboard of claim 14, wherein the at least a second of the plurality of keys is adapted to have a third mode and a fourth mode.

16. The keyboard of claim 14, wherein the at least one of the plurality of keys is further adapted to have at least a third mode.

17. The keyboard of claim 14, wherein the at least one of the plurality of keys exhibits a first characteristic behavior in the first mode and a second characteristic behavior in the second mode.

18. The keyboard of claim 17, wherein the first characteristic behavior is resistance of a key depression.

19. The keyboard of claim 17, wherein the first characteristic behavior is a haptic behavior of the at least one of the plurality of keys.

20. The keyboard of claim 14, wherein the first mode switches to the second mode based on a measurement of hover.
